(19) United States
(12) Patent Application Publication
(10) Pub. No.: US 2026/0357916 A1
(43) Pub. Date: Nov. 12, 2026

(54) ACTUATOR FOR A HEAT PUMP VALVE ASSEMBLY, VALVE ASSEMBLY FOR A HEAT PUMP AND HEAT PUMP WITH A VALVE ASSEMBLY

(71) Applicant: DANFOSS A/S, Nordborg (DK)

(72) Inventors: Mikkel FRANK, Nordborg (DK); Kristian THERKILDSEN, Nordborg (DK)

(21) Appl. No.: 19/129,808

(22) PCT Filed: Nov. 20, 2023
(86) PCT No.: PCT/EP2023/082401

§ 371 Date: May 14, 2025

(30) Foreign Application Priority Data
Nov. 21, 2022 (DK) PA202201066

(51) Int. Cl. F16K 27/00; F16K 31/04; F25B 41/20

(52) U.S. Cl. CPC F16K 27/00; F16K 31/04; F25B 41/20

(57) ABSTRACT

The present invention pertains to an actuator for a heat pump valve assembly. The actuator comprises a motor, a metallic housing and a heat management assembly with a metallic bottom flange portion, a metallic upper flange portion and a thermal insulating barrier provided between the bottom and upper flange portions, wherein the motor and the metallic housing are in direct contact with the metallic upper flange portion, and wherein the thermal insulating barrier consists of one or more components made of a material with a thermal conductivity of less than 1 W/(mK).

The invention is also directed at a valve assembly for a heat pump, comprising an actuator and a valve portion for controlling a fluid flow, wherein the vale assembly is connected to the actuator via the actuator's heat management assembly. The invention is further directed at a heat pump with a valve assembly.

### CROSS REFERENCE TO RELATED APPLICATION

This application is a national stage application under 35 U.S.C. § 371 of PCT Application No. PCT/EP2023/082401 filed Nov. 20, 2023, which claims priority to and the benefit of Danish Patent Application No. PA202201066 filed Nov. 21, 2022, the disclosure of each of which are incorporated herein by reference.

### BACKGROUND OF THE INVENTION

The disclosure pertains to an actuator for a heat pump valve assembly, i.e., a valve assembly for a heat pump. The actuator may comprise a motor, a metallic housing and a heat management assembly with a metallic bottom flange portion, a metallic upper flange portion and a thermal insulating barrier provided between the bottom and upper flange portions, wherein the motor and the metallic housing are in direct contact with the metallic upper flange portion, and wherein the thermal insulating barrier consists of one or more components made of a material with a thermal conductivity of less than 1 W/(mK).

The disclosure is also directed at a valve assembly for a heat pump, that may comprise an actuator and a valve portion for controlling a fluid flow, wherein the vale assembly is connected to the actuator via the actuator's heat management assembly. The invention is further directed at a heat pump that may have a valve assembly.

Actuators and valve assemblies are used for the control of refrigerant media of heat pumps. The term heat pumps as presently used may refer to more general vapour compression systems such as refrigeration systems, heat pump systems and air-conditioning systems. During the operation of the heat pumps, refrigerant media are compressed and expanded, which leads to significant temperature increases and reductions, especially at the valve assemblies.

The temperature impact from the compressed and expanded refrigerant media may typically be larger than the impact from the ambient temperatures. A problem arising from the considerable temperature fluctuations is that high and low temperatures may limit the performance of electronic components of, e.g., the actuator actuating the valve assembly.

### SUMMARY OF THE INVENTION

One aim of the disclosure is to overcome this problem. The aim is achieved by an improved actuator, an improved valve assembly with an actuator and an improved heat pump with a valve assembly. Additional aspects of the invention are contemplated herein.

In one aspect of the disclosure, broadly described herein, an actuator for a heat pump valve assembly is provided. The actuator comprises a motor, a metallic housing and a heat management assembly with a metallic bottom flange portion, a metallic upper flange portion and a thermal insulating barrier provided between the bottom and upper flange portions, wherein the motor and the metallic housing are in direct contact with the metallic upper flange portion, and wherein the thermal insulating barrier consists of one or more components made of a material with a thermal conductivity of less than 1 W/(mK).

The term metallic housing may refer to a part, which comprises at least some metallic components. The metallic housing may be made of metal or may be made substantially or at least partially of metal. At least a radially outer portion of the metallic housing and/or a portion of the metallic housing facing the heat management assembly may be made of metal, such as aluminium. The metallic component facilitates the heat transfer away from the motor.

According to the prior art, the motor may be provided in a fully non-metallic housing. One advantage of the presently described metallic housing is that it can be used for increasing the thermal coupling between the housed motor with the exterior of the motor via said metallic housing. In order to achieve this effect, the metallic housing and the motor may be directly coupled to the metallic upper flange portion via considerable metallic surface areas.

Some components of the metallic housing may be made of non-metallic components such as plastics, without significantly reducing the heat transfer capability of the metallic housing.

The thermal insulating barrier may be the entire volume or a part of the volume between the bottom and upper flange portions. The thermal insulating barrier may comprise all or some of the structures between the bottom and upper flange portions. The thermal insulating barrier may include air gaps providing significant thermal decoupling between the upper and lower flange portions. The thermal insulating barrier prevents low temperatures at the location of the electronic components of the actuator. Very low temperatures at the electronic components, induced by the fluid expansion at a valve connected to the actuator, may otherwise lead to malfunctioning electronics.

A magnetic coupling may be provided at least partially between the bottom and upper flange portions. The magnetic coupling may be provided for coupling the actuator to components of the valve assembly, such that a valve of the valve assembly may be opened and closed. The magnetic coupling may be regarded as part of the thermal insulating barrier or it may be regarded as a separate part from the thermal insulating barrier. The magnetic coupling may be made of components of higher thermal conductivity than the thermal insulating barrier, in particular metals.

The motor and the metallic housing are in direct contact with the metallic upper flange portion. This direct contact corresponds to a metal-on-metal contact, in which no intermediate components such as e.g. polymer seals are present between the metallic housing, the motor and the metallic upper flange portion. This direct contact maximises the heat transfer between the metallic housing and the metallic upper flange portion. The heat transfer between the motor, the metallic housing and the metallic upper flange portion may be additionally increased by providing e.g. some thermally conductive paste between the respective components.

The thermal insulating barrier is provided between the bottom flange area and the motor, e.g. a stepper motor and its electronic components. This construction makes it possible to significantly reduce the maximum and minimum temperature limits and/or the temperature fluctuations at the actuator.

In aspects, the thermal insulating barrier comprises a radially inner bushing, a radially outer thermal insulator and/or an O-ring provided between the inner bushing and the outer thermal insulator, wherein some or all components of the thermal insulating barrier are non-metallic and/or the metallic housing, at least a part of the motor and/or the metallic upper flange portion are made at least partially of aluminium. Clearly, some aluminium alloy may typically be used. The thermal insulating barrier may be provided in an volume between the bottom and upper flange portions. The volume occupied by the thermal insulating barrier may leave or exclude a radially central space for e.g. a magnetic coupling. The volume occupied by the thermal insulating barrier may be bound by flat faces of the bottom and upper flange portions and/or radially outer faces of the actuator.

In other aspects, at least one of the components of the thermal insulating barrier is made of a material with a thermal conductivity, which differs from the thermal conductivity of the material of at least one of the flange portions by at least one order of magnitude, wherein the thermal conductivity of the at least one component of the thermal insulating barrier (15) is in a range between 0.15 W/(mK) to 0.28 W/(mK) and in some aspects may be in a range between 0.19 W/(mK) to 0.24 W/(mK). As the thermal insulating barrier may comprise air gaps, said air gaps may also be regarded as components of the thermal insulating barrier. The air gaps may be provided around or next to the solid components of the thermal insulating barrier. Including air gaps effectively reduces thermal conductivity between the flange portions.

In still other aspects, the thermal insulator has radially outer and/or inner faces of circular shape, wherein the distance between the radially inner and outer faces varies over the circumference of the thermal insulator. In yet other aspects, the thermal insulator comprises through holes extending in an axial direction. In other aspects, the thermal insulator comprises at least one concave and/or hollow portion and/or the thermal insulator contacts the flange portions via at least two circumferential support portions and/or the thermal insulator has an H-shaped cross section. The thermal insulator may be shaped to provide air pockets, accommodate features such as screws or bolts, provide contact surfaces for contacting the flange portions and any further suitable functionalities.

In still other aspects, the O-ring and the thermal insulator have the same extension in the axial direction of the valve assembly. The O-ring and the thermal insulator may be provided between two parallel, equidistant faces of the flange portions.

In other aspects, the bushing extends further in the axial direction of the valve assembly than the thermal insulator and/or the O-ring. The bushing may facilitate the centring of the two flange portions with respect to each other.

In other aspects, the radially inner and/or outer sides of the bushing are in direct contact with air over at least a portion of their entire surface areas. The bushing may be supported against its adjacent components such that air pockets may be retained between the bottom and upper flange portions, improving the thermal decoupling of the two components.

In other aspects, radially inner and outer faces and/or axially upper and bottom faces of the thermal insulator are in direct contact with air over at least a portion of their entire surface areas. The components of the thermal insulator may be shaped such that they allow for significant volumes of air to be provided between the bottom and upper flange portions. As a result, the volume of the gap between the bottom and upper flange portions may comprise between 10% and 50% of air volume.

In other aspects, electronic control components of the actuator are provided in a synthetic housing connected to the metallic housing opposite the thermal insulating barrier. The division of the housing into two separate sub-housings, the metallic housing and the synthetic housing helps reducing the heat transfer from the metallic housing into the electronic components of the actuator.

In other aspects, the metallic housing is in direct contact with the metallic upper flange portion via a circumferential contact surface. The circumferential contact surface may have a cylindrical shape and may correspond to a radially inner surface of the metallic housing and a radially outer surface of the upper flange portion

In other aspects, the thermal insulating barrier has a heat transferring capability equivalent to the heat transferring capability of a plastic material thermal insulator having a thickness of between 1 mm and 8 mm and a horizontal cross sectional surface area equal to or smaller than the horizontal cross sectional area of the thermal insulating barrier, wherein the horizontal cross sectional surface area of the plastic material thermal insulator is between 25% and 100%, and in some aspects may be between 50% and 75% of the horizontal cross sectional area of the thermal insulating barrier and/or the thickness of the plastic material thermal insulator is between 4 mm and 7 mm and in some aspects may be 5.5 mm±0.5 mm. The horizontal cross sectional area of the thermal insulating barrier may be defined as the area between the bottom and upper flange portions which is bound by the outside of the thermal insulator on its radially outer side and by the inside of the bushing on its radially inner side.

The invention is also directed at a valve assembly for a heat pump, that may comprise an actuator according to one or more of the aforementioned aspects and a valve portion for controlling a fluid flow, wherein the vale assembly is connected to the actuator via the actuator's heat management assembly.

The invention is further directed at a heat pump with a valve assembly according to one or more of the aforementioned aspects.

Further details and advantages of the invention are described with reference to the embodiments shown in the Figures.

### BRIEF DESCRIPTION OF THE DRAWINGS

FIG. 1a is a sectional view of an actuator with a valve portion according to an aspect of the disclosure;

FIG. 1b is a sectional views of an actuator with a valve portion according to an aspect of the disclosure;

FIG. 2 is a detailed sectional view of a heat management assembly according to an aspect of the disclosure; and

FIG. 3a is a detailed view of a thermal insulating barrier and a thermal insulator according to an aspect of the disclosure; and

FIG. 3b is a detailed view of a thermal insulating barrier and a thermal insulator according to an aspect of the disclosure.

### DETAILED DESCRIPTION

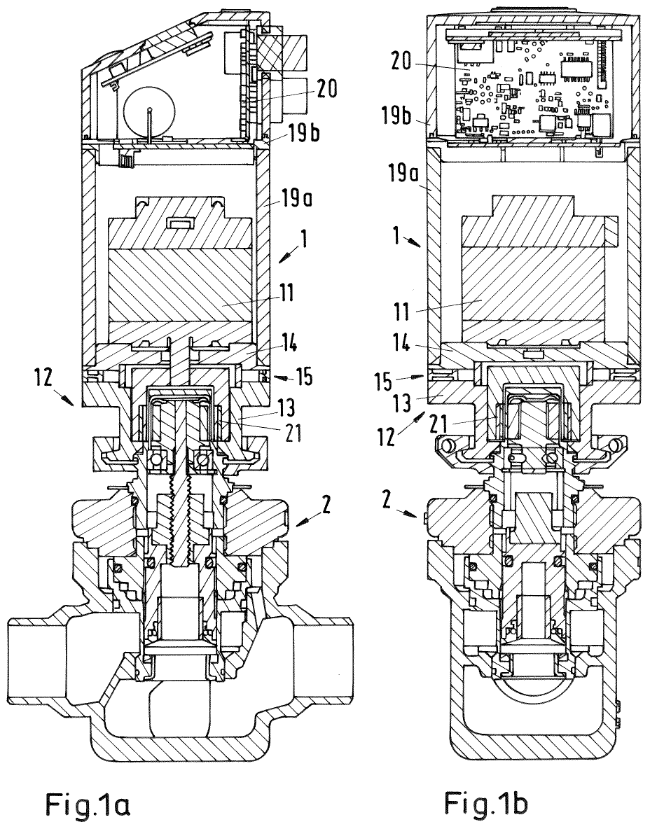

FIGS. 1a and 1b are sectional views of aspects of the disclosure with an actuator 1 and a valve portion 2 attached to each other. The actuator 1 may comprise a motor 11, a metallic housing 19a and a heat management assembly 12 with a metallic bottom flange portion 13, a metallic upper flange portion 14 and a thermal insulating barrier 15 provided between a bottom and upper flange portions 13, 14. The actuator 1 may comprise any components required for actuating a valve of the valve portion 2. The actuator 1 may comprise the motor 11, the metallic housing 19a and/or electronic control components 20 for controlling the motor 11.

The valve portion 2, the thermal insulating barrier 15, the motor 11 and its electronic control components 20 may be aligned in an axial direction with respect to each other. The axial direction may correspond to the vertical direction in FIGS. 1a and 1b and to the axis of rotation of the motor 11.

The term metallic housing 19a may refer to a part, which comprises at least some metallic components, situated close to the thermal insulating barrier 15. Other components housing the motor 11, such as a synthetic housing 19b may be made of non-metallic components such as plastics. The non-metallic components may be situated at an opposite end to the thermal insulating barrier 15.

Electronic control components 20 of the actuator 1 are provided in the synthetic housing 19b. The division of the housing into two separate sub-housings, the metallic housing 19a and the synthetic housing 19b, helps reducing the heat transfer from the metallic housing 19a into the electronic components 20 situated in the synthetic housing 19b.

FIGS. 1a and 1b show a valve assembly for a heat pump. The valve assembly comprises the actuator 1 and the valve portion 2 for controlling a fluid flow. The valve portion 2 is connected to the actuator 1 via the actuator's 1 heat management assembly 12. The connection between the actuator 1 and the valve portion 2 may include additional components other than the heat management assembly 12, such as a magnetic coupling 21.

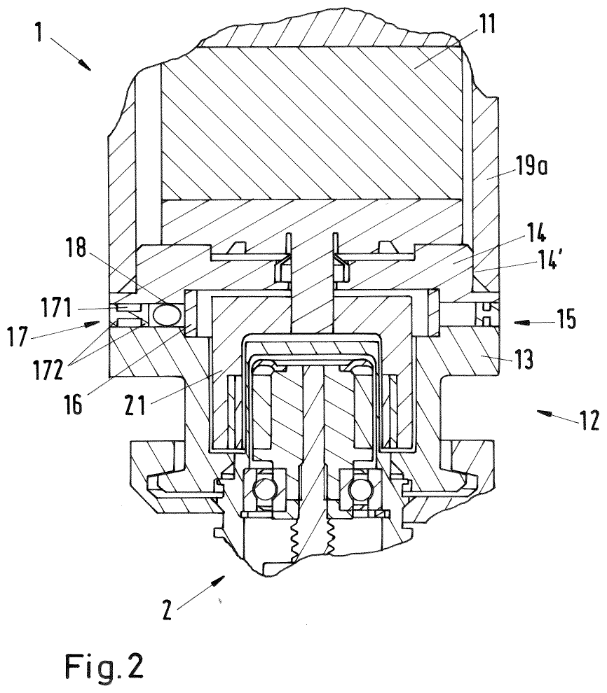

FIG. 2 is a detailed sectional view of the heat management assembly 12 and adjacent structures.

The actuator 1, its motor 11 and the metallic housing 19a contact the valve portion 2 via the heat management assembly 12 of the actuator 1. The heat management assembly 12 comprises the two flange portions 13, 14 and the thermal insulating barrier 15, situated in between the two flange portions 13, 14.

The motor 11 and the metallic housing 19a are in direct contact with the metallic upper flange portion 14. The motor 11 and the upper flange portion 14 are in contact with each other via their respective axial end portions. Their axial end portions may be planar faces, which in some aspects extend in a radial direction. The metallic housing 19a and the upper flange portion 14 contact each other via their circumferential contact surfaces 14′ and/or via their respective axial end portions.

The upper flange portion 14 may have two distinct axial end portions, one of them contacting the motor 11 and the other one contacting the metallic housing 19a. The two distinct axial end portions may be parallel to each other and/or may be offset to each other in the axial direction. The axial end portion for contacting the metallic housing 19a may be closer to the bottom flange portion 13 than the axial end portion for contacting the motor 11. The axial end portion for contacting the metallic housing 19a may be radially further outside than the end portion for contacting the motor 11.

The metallic housing 19a is in direct contact with the metallic upper flange portion 14 via a circumferential contact surface 14′. The circumferential contact surface 14′ may have a cylindrical shape and may correspond to a radially inner surface of the metallic housing 19a and a radially outer surface of the upper flange portion 14.

The circumferential contact surface 14′ may extend over the entire circumference of the upper flange portion 14 and the metallic housing 19a. The upper part of the metallic upper flange portion 14 may be partially or fully inserted into the metallic housing 19a. The entire upper part of the upper flange portion 14 may be provided radially inside the bottom part of the metallic housing 19a.

Reference to upper portions means closer to the actuator 1, while reference to bottom portions means closer to the valve 2. The upper flange portion 14 may extend from approximately the external radius of the metallic housing 19a to a central through hole accommodating parts of a coupling for coupling the motor 11 to the valve portion 2, such as a shaft. The central through hole of the upper flange portion 14 may have a diameter smaller than 20%, which in some aspects is smaller than 15% and still other aspects between 8% and 12% of the outer diameter of the upper flange portion 14.

The upper flange portion 14 may be arranged concentrically to the motor 11 and/or to the metallic housing 19a. The upper flange portion 14 may be a separate component from components housing the valve 2.

The upper flange portion 14 may comprise a radially outer toroidal portion for contacting the axial end portion of the metallic housing 19a. The radially outer toroidal portion may be the lowest portion of the upper flange portion 14, i.e. it may be positioned closest to the valve 2. The upper flange portion 14 may comprise an upper recessed portion for contacting and centering the motor 11 with respect to the upper flange portion 14. The upper flange portion 14 may comprise a bottom recessed portion for contacting a bushing 16.

The thermal insulating barrier 15 may have a heat transferring capability equivalent to the heat transferring capability of a plastic material thermal insulator having a thickness of between 1 mm and 8 mm and a horizontal cross sectional surface area equal to or smaller than the horizontal cross sectional area of the thermal insulating barrier 15, wherein the horizontal cross sectional surface area of the plastic material thermal insulator is between 25% and 100%, and in some aspects between 50% and 75% of the horizontal cross sectional area of the thermal insulating barrier 15 and/or the thickness of the plastic material thermal insulator is between 4 mm and 7 mm and in some aspects between 5.5 mm±0.5 mm.

The horizontal cross sectional area of the thermal insulating barrier 15 may be defined as the area between the bottom and upper flange portions 13, 14, bound by the radially outer side of the thermal insulator 17 and by the radially inner side of the bushing 16. The shape of the horizontal cross sectional area may correspond to a rectangular shape with or without a circular and/or coaxial hole at its centre.

The thermal insulating barrier 15 may be the entire volume or a part of the volume between the bottom and upper flange portions 13, 14. The thermal insulating barrier 15 may comprise all or some of the structures and components between the bottom and upper flange portions 13, 14. At least one or more components of the thermal insulating barrier 15 are made of a material with a thermal conductivity of less than 1 W/(mK).

A magnetic coupling 21 may be provided at least partially between the bottom and upper flange portions 13, 14. The magnetic coupling 21 may comprise various sub-components provided for coupling the motor 11 to components of the valve assembly 2, such that a valve of the valve assembly 2 may be opened and closed by the motor 11. All components of the magnetic coupling 21 may be provided below the upper flange portion 14 and/or above the housing and/or a bonnet of the valve 2. Radially internal components of the magnetic coupling 21 may be provided in a sealed compartment, said compartment may contain bearing components and/or mechanical transmission components for coupling the motor 11 to movable components of the valve assembly 2. The sealed compartment may protrude from the structure of the housing of the valve 2. Radially outer components of the magnetic coupling 21 may be provided radially outside of the internal components of the magnetic coupling 21 for providing a corresponding magnetic interaction. All magnetic parts of the magnetic coupling 21 may be provided above a contact surface, at which the valve 2 contacts the actuator 1.

The magnetic coupling 21 may be regarded as part of the thermal insulating barrier 15 or it may be regarded as a separate part from the thermal insulating barrier 15. The magnetic coupling 21 may be made of components of higher thermal conductivity than the thermal insulating barrier 15, in particular metals.

The motor 11 and the metallic housing 19a are in direct contact with the metallic upper flange portion 14. This direct contact corresponds to a metal-on-metal contact, in which no intermediate components such as e.g. polymer seals are present between the metallic housing 19a, the motor 11 and the metallic upper flange portion 14. This direct contact maximises the heat transfer between the metallic housing 19a and the metallic upper flange portion 14. The heat transfer between the metallic housing 19a and the metallic upper flange portion 14 may be additionally increased by providing e.g. some thermally conductive paste between the two adjacent components. Through the direct contact between the metallic housing 19a and the upper flange portion 14, the metallic housing 19a acts as a heat sink for the actuator 1.

The thermal insulating barrier 15 may comprise various components for ensuring a thermal decoupling of the upper and lower flange portions 13, 14, while at the same time providing sufficient mechanical support between the upper and lower flange portions 13, 14.

The thermal insulating barrier 15 comprises a radially inner bushing 16, a radially outer thermal insulator 17 and/or an O-ring 18 provided between the inner bushing 16 and the outer thermal insulator 17. A cross section of the O-ring 18 is shown only on the left side of the thermal insulating barrier 15, however, the O-ring 18 may clearly extend along the entire circumference of the thermal insulating barrier 15. Some or all components of the thermal insulating barrier 15 may be non-metallic for reducing heat transfer across the thermal insulating barrier 15.

The metallic housing 19a, at least a part of the motor 11 and/or the metallic upper flange portion 14 may be made at least partially of aluminium. The thermal insulating barrier 15 may be provided in an cuboid volume between the bottom and upper flange portions 13, 14. The volume occupied by the thermal insulating 15 barrier may leave or exclude a radially central or annular space for e.g. the magnetic coupling 21.

The components of the thermal insulating barrier 15 may not fill the entire volume between the upper and lower flange portions 13, 14. Rather, they may be shaped for providing air gaps capable of providing significant thermal decoupling between the upper and lower flange portions 13, 14.

As the thermal insulating barrier 15 may comprise air gaps, said air gaps may also be regarded as components of the thermal insulating barrier 15. The air gaps may be provided around or next to the solid components of the thermal insulating barrier 15. Including air gaps effectively reduces thermal conductivity between the flange portions 13, 14.

The O-ring 18 and the thermal insulator 17 have the same extension in the axial direction of the valve assembly 2. The O-ring 18 and the thermal insulator 17 may be provided between two parallel, equidistant faces of the flange portions 13, 14. The O-ring 18 and the thermal insulator 17 may be made of some elastic material, such that they may be compressed in their assembled state shown in FIG. 2. The material of the O-ring 18 and the thermal insulator 17 may be of higher elasticity than the material of the bushing 16.

The bushing 16 may extend further in the axial direction of the valve portion 2 and/or the motor 11 than the thermal insulator 17 and/or the O-ring 18. The bushing 17 may define the distance between the flange portions 13, 14. The bushing 17 may centre the two flange portions 13, 14 with respect to each other.

The radially inner and/or outer sides of the bushing 16 are in direct contact with air over at least a portion of their entire surface areas. The bushing 16 may be supported against its adjacent components such that air pockets may be retained between the bottom and upper flange portions 13, 14, improving the thermal decoupling of the two components. The radially outer side of the bushing 16 and the circular axial end portions of the bushing 16 may be at least partially in contact with the bottom and upper flange portions 13, 14. The radially outer side of the bushing 16 and the circular axial end portions of the bushing 16 may be the only portions of the bushing 16 contacting the bottom and upper flange portions 13, 14. The bottom and upper flange portions 13, 14 may each comprise a recess for at least partially receiving axial ends of the bushing 16.

Radially inner and outer faces and/or axially upper and bottom faces of the thermal insulator 17 are in direct contact with air over at least a portion of their entire surface areas. The components of the thermal insulator 17 may be shaped such that they allow for significant volumes of air to be provided between the bottom and upper flange portions 13, 14. As a result, the volume of the gap between the bottom and upper flange portions 13, 14 may comprise between 10% and 50% of air. The insulator 17 and/or the O-ring 18 may seal air pockets against the bottom and upper flange portions 13, 14 such that air is held inside the air pockets.

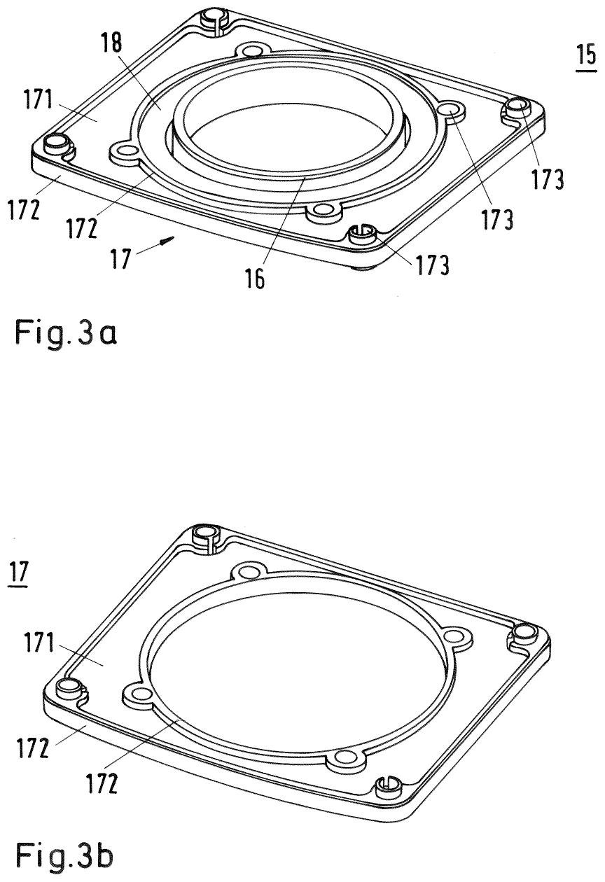

FIGS. 3a and 3b show detailed views of the thermal insulating barrier 15 with its components and the thermal insulator 17 as one of the components of the thermal insulating barrier 15 . The thermal insulator 17 has radially outer and/or inner faces, which in certain aspects are circular and/or rectangular shape. In the embodiment of FIGS. 3a and 3b, only the radially inner face is of a circular shape. The radially inner and outer faces extend in the axial direction. The distance between the radially inner and outer faces varies over the circumference of the thermal insulator 17. Thus, the thermal insulator 17 may be provided for accommodating e.g. a circular magnetic coupling 21 shown in FIG. 2 and/or the circular bushing 16 and/or the circular O-ring 18 at its radially inner side. At the same time, a rectangular metallic housing 19a may be contacting the radially outer side of the thermal insulator via the upper flange portion 14 as also shown in FIG. 2.

The thermal insulator 17 comprises through holes 173 extending in an axial direction. The thermal insulator 17 further comprises at least one concave and/or hollow portion 171. Hollow portions 171 may be provided on each side of the thermal insulator 17 facing the bottom 13 and upper flange portion 14.

The hollow portion 171 may be bound by support portions 172 projecting axially from the hollow portion 171. The support portions 172 may be the radially innermost and/or outermost portions of the thermal insulator 17.

The thermal insulator 17 contacts the flange portions 13, 14 via the at least two circumferential support portions 172. The thermal insulator 17 has an at least partially H-shaped cross section. The H-shaped cross section refers to the horizontal hollow portion 171 being bound by the radially inner and outer support portions 172, thus forming an H-shaped structure as shown on the left and right sides of the thermal insulator 17 in FIG. 2.

The thermal insulator 17 may be shaped to provide air pockets, accommodate features such as screws or bolts, provide contact surfaces for contacting the flange portions 13, 14 and any further suitable functionalities.

Air pockets may be bound by horizontal faces of the hollow portion 171 and vertical faces of the support portions 172. Air pockets may be provided adjacent to the O-ring 18, in particular between the O-ring 18 and the thermal insulator 17 on one side and between the O-ring 18 and the bushing 16 on an opposite site of the O-ring 18, preferably in a radial direction. Air pockets may be provided between the bushing 16 and the magnetic coupling 21.

1. An actuator for a heat pump valve assembly, comprising:
a motor, a metallic housing, and a heat management assembly with a metallic bottom flange portion, a metallic upper flange portion, and a thermal insulating barrier provided between the metallic bottom flange portion and the metallic upper flange portions;
wherein the motor and the metallic housing are in direct contact with the metallic upper flange portion; and
wherein the thermal insulating barrier consists of at least one component made of a material with a thermal conductivity of less than 1 W/(mK).

2. The actuator of claim 1, further comprising the thermal insulating barrier having an inner bushing, an outer thermal insulator and an O-ring provided between the inner bushing and the outer thermal insulator, wherein at least one component of the thermal insulating barrier is non-metallic.

3. The actuator of claim 1, wherein at least one component of the thermal insulating barrier is made of a material with a thermal conductivity, which differs from the thermal conductivity of a material of at least one of the metallic bottom flange portion and the metallic upper flange portion by at least one order of magnitude.

4. The actuator of claim 2, wherein the outer thermal insulator has a radially outer and inner faces having a circular shape, wherein a distance between the radially outer and inner faces varies over a perimeter of the outer thermal insulator.

5. The actuator of claim 2, further comprising the outer thermal insulator having through holes extending in an axial direction.

6. The actuator of claim 2, further comprising the outer thermal insulator having at least one of at least one concave and a hollow portion.

7. The actuator of claim 2, wherein the O-ring and the outer thermal insulator extend in the same axial direction of a valve assembly.

8. The actuator of claim 2, wherein the inner bushing extends further in an axial direction of a valve assembly with relation to at least one of the outer thermal insulator and the O-ring.

9. The actuator of claim 2, characterized in that radially inner and outer sides of the inner bushing are in direct contact with air over at least a portion of their entire surface areas.

10. The actuator of claim 2, wherein at least one of a radially inner face and an outer face and an axially upper face and a bottom face of the outer thermal insulator are in direct contact with air over at least a portion of their entire surface areas.

11. The actuator of claim 1, wherein an electronic control components of the actuator are provided in a synthetic housing connected to the metallic housing opposite the thermal insulating barrier.

12. The actuator of claim 1, wherein the metallic housing is in direct contact with the metallic upper flange portion via a circumferential contact surface.

13. The actuator of claim 1, further comprising the thermal insulating barrier having a heat transferring capability equivalent to the heat transferring capability of a plastic material thermal insulator having a thickness between 1 mm and 8 mm and a horizontal cross sectional surface area equal to or smaller than a horizontal cross sectional surface area of the thermal insulating barrier.

14. The actuator of claim 1, further comprising a valve assembly having a valve portion for controlling a fluid flow connected to the actuator via a heat management assembly of the actuator.

15. The actuator of claim 14, further comprising a heat pump connected to the valve assembly.

16. The actuator of claim 2, wherein the metallic housing and at least a part of one of the motor and the metallic upper flange portion are made partially of aluminium.

17. The actuator of claim 3, wherein the thermal conductivity of the at least one component of the thermal insulating barrier is in a range between 0.15 W/(mK) to 0.28 W/(mK).

18. The actuator of claim 3, wherein the thermal conductivity of the at least one component of the thermal insulating barrier is in a range between 0.19 W/(mK) to 0.24 W/(mK).

19. The actuator of claim 6, wherein the outer thermal insulator contacts the metallic upper flange portion and the metallic bottom flange portion via at least two circumferential support portions.

20. The actuator of claim 6, wherein the outer thermal insulator has an H-shaped cross section.

21. The actuator of claim 13, wherein the horizontal cross sectional surface area of the plastic material thermal insulator is between 25% and 100% of a horizontal cross sectional area of the thermal insulating barrier and the thickness of the plastic material thermal insulator is between 4 mm and 7 mm.

22. The actuator of claim 13, wherein the horizontal cross sectional surface area of the plastic material thermal insulator is between 50% and 75% of a horizontal cross sectional area of the thermal insulating barrier and the thickness of the plastic material thermal insulator is 5.5 mm±0.5 mm.
